(19) United States
(12) Patent Application Publication
(10) Pub. No.: US 2015/0348675 A1
(43) Pub. Date: Dec. 3, 2015

(54) SILVER NANOWIRE THIN FILM, MANUFACTURING METHOD THEREOF, AND ARRAY SUBSTRATE AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Lianjie QU, Beijing (CN); Jian GUO, Beijing (CN)

(21) Appl. No.: 14/498,534

(22) Filed: Sep. 26, 2014

(30) Foreign Application Priority Data
May 29, 2014 (CN) 201410235754.5

(51) Int. Cl. H01B 7/04; H01B 1/02; H01B 3/46; C23F 1/02; C23C 28/00

(52) U.S. Cl. CPC H01B 7/04; C23F 1/02; C23C 28/32; H01B 3/46; H01B 1/02

(57) ABSTRACT

A silver nanowire thin film comprising a silver nanowire layer formed over a base substrate and a protective layer formed over the silver nanowire layer. A method for manufacturing the silver nanowire thin film comprising: forming a silver nanowire layer over a base substrate; forming a protective layer over the silver nanowire layer; forming a pattern of the silver nanowire layer covered with the protective layer thereon through a patterning process. An array substrate and a display device are further provided.

### TECHNICAL FIELD

Embodiments of the present disclosure relate to a silver nanowire thin film and manufacturing method thereof, an array substrate and a display device.

### BACKGROUND

A transparent conductive thin film is widely used in an optical-electrical field of a panel display, a solar cell, a light emitting device, an optical communication apparatus, a solid-state lighting and etc. In recent years, a transparent conductive thin film which is formed on a flexible substrate has advantage of being foldable, light weight, non-shattering, transportable, being mass produced and requiring low equipment investment etc. Thus a transparent conductive thin film can be applied to the optical-electrical field and becomes a new direction of the study on the transparent conductive thin film in recent years. A transparent conductive thin film widely applied industrially is made of indium tin oxide (ITO), but its wide application is limited in new flexible electronic devices due to insufficient reserve of the metal, toxicity of indium, fragility of ITO electrodes, instability of its chemical property, non-resistance to acids or alkali, low transmissivity for infra-red light and high cost.

Subsequently, corresponding materials for replacing the ITO transparent conductive thin film is under development, among them, a silver nanowire material is a more promising material. The silver nanowire is a nano material with a diameter of about 30 nm and a length of about tens of micrometers. With respect to the ITO, the silver nanowire material has a superior conductive performance and a nano-structure property while having a flexible property and a superior price advantage. But the silver nanowire tends to be oxidized, and oxidation of the silver nanowire will greatly deteriorate performance and lifetime of the product.

Silver oxide, a brown or cinereous solid and with a chemical formula of Ag₂O, a molecular weight of 231.74 and a density of 7.143 g/cm³, will be quickly decomposed into silver and oxygen at a temperature of 300° C., is slightly soluble in water and very soluble in nitric acid, ammonia liquor, a solvent of hyposulphite and potassium cyanide, and its ammonia solution needs to be disposed in time after use, otherwise a black crystal of violent explosive (i.e. silver nitride or Ag₂NH) will be precipitated after a long stand. Silver oxide is used as an oxidizer or a glass coloring agent and is obtained through reaction of sodium hydroxide solution and silver nitrate solution.

In an actual process, a high temperature process is usually used, e.g. during manufacturing a touch sensor product, it needs to deposit silicon nitride on a transparent conductive electrodes at a deposition temperature of about 300° C., under which temperature Ag₂O is very easy to be decomposed, and O₂ generated due to decomposition will seriously damage to upper layer films, such as breakdown and bubbles, causing short circuit and etc. of upper and lower metal layers.

### SUMMARY

According to an embodiment of the present disclosure, a method of manufacturing a silver nanowire thin film is provided, which comprises:
forming a silver nanowire layer over a base substrate;
forming a protective layer over the silver nanowire layer;
performing a reduction process to the silver nanowire layer formed with the protective layer; and
forming a pattern of silver nanowire covered with the protective layer through a patterning process.

According to another embodiment of the present disclosure, a silver nanowire thin film is provided, which comprises a silver nanowire layer formed over a base substrate and a protective layer formed over the silver nanowire layer.

According to still another embodiment of the present disclosure, an array substrate is provided, which comprises a transparent conductive thin film is made of the silver nanowire thin film as described above.

According to yet another embodiment of the present disclosure, a display device is provided which comprises the array substrate as described above.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIGS. 1 to 3 illustrate flow charts of forming a silver nanowire thin film according to an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

To solve the problem that a silver nanowire is prone to be oxidized when forming a transparent conductive thin film by a silver nanowire thin film, which is known to the inventor of the present disclosure, a safer and more reliable silver nanowire thin film is provided, which comprises a silver nanowire layer formed over a base substrate and a protective layer formed over the silver nanowire layer. The silver nanowire layer is protected from being oxidized by adding a protective layer. And further, by introducing an anti-oxidation process for a silver nanowire into a film forming process of the silver nanowire thin film, oxidation of the silver nanowire layer due to long time stand is mitigated, and at the same time conductive performance of the silver nanowire layer can be enhanced, thus the product performance and lifetime are improved.

### Embodiment 1

The silver nanowire thin film according to the present embodiment comprises a silver nanowire layer formed over the base substrate and a protective layer formed over the silver nanowire layer, enabling the silver nanowire layer to function as a conductive thin film with the protective layer protecting the silver nanowire layer from being oxidized, so that the performance and lifetime of the product are improved.

A thickness of the silver nanowire layer is 100 nm to 1 μm. In terms of the thickness, the thickness of the silver nanowire layer designed will differ depending on various resistances required. A diameter of a single silver nanowire ranges from tens of nanometers to hundreds of nanometers. The silver nanowire layer comprises at least two layers of the silver nanowires, with a thickness from 100 nm to 1 μm.

The protective layer mentioned above is made of a high temperature resistant material which can endure a temperature of above 300° C. In an embodiment, the protective layer is made of a material such as silicone; a thickness of the protective layer is more than 500 nm to completely cover the silver nanowire layer by the protective layer in order to protect the silver nanowire layer from being oxidized.

In the silver nanowire thin film structure according to the present embodiment, the silver nanowire layer is protected from being oxidized through adding a protective layer and the performance and lifetime of the product which adopts the silver nanowire thin film structure are improved.

### Embodiment 2

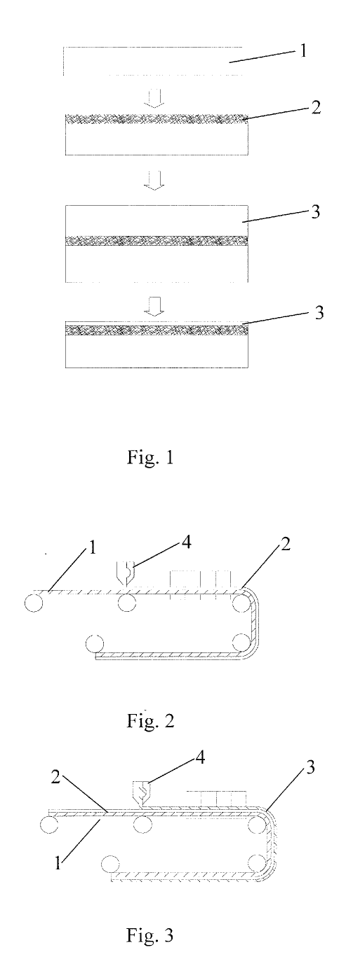

Based on the structure of the silver nanowire thin film as described in the embodiment 1, the present embodiment provides a manufacturing method for the silver nanowire thin film to reduce impact on the subsequent process of oxidation of the silver nanowire. The method will be explained by referring to FIGS. 1 to 3.

1. Uniformly Coating a Silver Nanowire Layer 2 over the Substrate 1.

The coating can be performed in a manner of spreading or spin coating. The silver nanowire layer has a thickness of 100 nm to 1 μm, and in terms of the thickness, the thickness of the designed silver nanowire layer will differ depending on various resistances required. A diameter of a single silver nanowire is tens of nanometers to hundreds of nanometers. The silver nanowire layer comprises at least two layers of the silver nanowires, with a thickness between 100 nm and 1 μm.

2. Drying.

Since silver nanowires dissolve in ink, it needs to perform a drying process to vaporize most of solution therein, to obtain a silver nanowire layer with a certain degree of rigidness.

While the solution being vaporized, it needs to perform the drying at a high temperature to enable the silver oxide to be pre-reduced, as reduction can not be carried out to the silver oxide at a low drying temperature. In an embodiment, the drying is carried out at a temperature above 300 □. In another embodiment, the drying treatment is performed to the silver nanowire layer in an atmosphere of non-oxidizing gases such as nitrogen with a high temperature between 300 □-350 □. Usually, the drying lasts for from half an hour to one hour.

3. Coating a Protective Layer: Coating a Protective Layer 3 with a Certain Thickness on a Surface of the Silver Nanowire Layer 2.

The coating can be performed in a manner of spreading, such as the blade 4 illustrated in FIGS. 2 and 3, or in a manner of spin coating.

The protective layer is made of a high temperature resistant material which can endure a temperature above 300° C. In an embodiment, the protective layer is made of a material such as silicone, to be able to endure the drying temperature.

4. Drying: Drying at a Certain Temperature to Cure the Protective Layer;

In an embodiment, the drying is performed to the protective layer at a temperature of 300° C.-350° C. Drying at this temperature can also enable the silver nanowire layer to be reduced.

5. Coating Photoresist.

Photoresist is uniformly coated on the protective layer. The photoresist is exposed through a mask with a certain pattern and developed to form a certain pattern on the photoresist. Then, a post-drying process is performed to increase adhesion between the photoresist and the protective layer. And then, the protective layer and the silver nanowire layer having a photoresist pattern are etched. Usually a wet etching is performed to corrode the protective layer and the silver nanowire layer which are not covered and protected by the photoresist by means of an etching solvent; finally the photoresist is peeled off by means of a peeling solvent.

So, a patterning process for the entire silver nanowire layer is completed.

In the above embodiment, the silver nanowire layer can be dried at a low temperature, and then coated with a protective layer. The protective layer is dried at a high temperature above 300° C., enabling the silver nanowire layer to be reduced, so that the two functions, drying and reducing resistances, can be realized as well.

Based on the above embodiments 1 and 2, embodiments of the present disclosure further disclose an array substrate, a transparent conductive thin film of which is made of the silver nanowire thin film as described above.

Embodiments for the present disclosure further discloses a display device which comprises the array substrate as described above, and the display device can be any product or component with a displaying function, such as a liquid crystal panel, an electronic paper, a liquid crystal TV, a liquid crystal display device, a digital frame, a cell phone, a tablet PC and so on.

As can be seen from the above embodiments, in the silver nanowire thin film structure, the silver nanowire layer is protected and kept from being oxidized by adding a protective layer; further, by introducing an anti-oxidation process for the silver nanowire into a forming process of the silver nanowire thin film, film layer oxidation of the silver nanowire layer due to long time stand is mitigated while conductive performance of the silver nanowire layer can be enhanced, so that the product performance and lifetime are improved.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 2014102357450.5 filed on May 29, 2014, the disclosure of which is hereby entirely incorporated by reference.

1. A method for manufacturing a silver nanowire thin film, comprising:
forming a silver nanowire layer over a base substrate;
forming a protective layer over the silver nanowire layer;
performing a reduction process to the silver nanowire layer formed with the protective layer; and
forming a pattern of silver nanowire covered with the protective layer thereon through a patterning process.

2. The method according to claim 1, wherein performing a reduction process to the silver nanowire layer formed with the protective layer comprises:
drying the protective layer at a temperature of 300° C.-350° C., with the protective layer made of a high temperature resistant material.

3. The method according to claim 1, further comprising performing a pre-reduction process to the silver nanowire layer before forming the protective layer over the silver nanowire layer, and the pre-reduction process comprising:
drying the silver nanowire layer at a temperature of 300° C.-350° C. at an atmosphere of a non-oxidizing gas.

4. The method according to claim 2, further comprising performing a pre-reduction process to the silver nanowire layer before forming the protective layer over the silver nanowire layer, and the pre-reduction process comprising:
drying the silver nanowire layer at a temperature of 300°C.-350° C. in an atmosphere of a non-oxidizing gas.

5. The method according to claim 1, wherein forming a pattern of silver nanowire pattern through a patterning process comprises:
uniformly coating a layer of photoresist on the silver nanowire layer;
exposing through a mask and developing to form a pattern of the photoresist;
performing a post-drying process, to increase adhesion between the photoresist and the protective layer;
etching the protective layer and the silver nanowire layer with the pattern of the photoresist, wherein wet etching is performed to corrode the protective layer and the silver nanowire layer not protected by the photoresist by using an etching solvent; and
peeling off the photoresist by means of a peeling solvent.

6. The method according to claim 2, wherein the protective layer is made of silicone.

7. A silver nanowire thin film comprising:
a silver nanowire layer formed over a base substrate; and
a protective layer formed over the silver nanowire layer.

8. The silver nanowire thin film according to claim 7, wherein the silver nanowire layer has a thickness of 100 nm to 1 μm, and a thickness of the protective layer is more than 500 nm.

9. The silver nanowire thin film according to claim 7, wherein the protective layer is made of a high temperature resistant material which can endure a temperature above 300° C.

10. The silver nanowire thin film according to claim 7, wherein the protective layer is made of silicone.

11. An array substrate, comprising a transparent conductive thin film that is made of the silver nanowire thin film according to claim 7.

12. A display device comprising the array substrate according to claim 11.
